(19) United States
(12) Patent Application Publication
(10) Pub. No.: US 2011/0059426 A1
(43) Pub. Date: Mar. 10, 2011

(54) Book

(75) Inventor: Hrand Mami Mamigonians, London (GB)

(73) Assignee: HM TECHNOLOGY INTERNATIONAL LIMITED, Perivale (GB)

(21) Appl. No.: 12/649,450

(22) Filed: Dec. 30, 2009

(30) Foreign Application Priority Data
Sep. 4, 2009 (GB) 09 15 438.6

(51) Int. Cl. G09B 5/00

(52) U.S. Cl. 434/317

(57) ABSTRACT

A book for displaying images and playing associated audio content. The book comprises a plurality of leaves defining pages of the book. A plurality of pairs of transmitters and receivers are arranged on the leaves, so that a plurality of the leaves each has a transmitter and a plurality of the leaves each has a receiver. Capacitance coupling between a transmitter and its paired receiver depends upon whether a page of the book is open. The book has a controller configured to provide pulsed signals to the transmitters and receive signals from the receivers. In addition the book has memory for audio content and an audio playback device. The controller is configured to identify any open page of the book by comparing signals received by the receivers from the transmitters to a threshold value. If only one page is open, the controller identifies associated audio content relevant to the open page from audio stored in the memory and identified audio is played on the audio playback device.

### CROSS REFERENCE TO RELATED APPLICATIONS

This application claims priority from United Kingdom Patent Application No. 09 15 438.6, filed 4 Sep. 2009, the whole contents of which are incorporated herein by reference in their entirety.

### BACKGROUND OF THE INVENTION

1. Field of the Invention

The present invention relates to a book or album for displaying images and playing associated audio content.

2. Description of the Related Art

Books for displaying images are known. Some of these books have the facility for playing associated audio content. Previous mechanisms for playing appropriate portions of audio content to correspond with images include a user pressing a button to select which page they are on, or mechanisms with moving contacting parts which detect open pages.

### BRIEF SUMMARY OF THE INVENTION

According to a first aspect of the present invention, there is provided a book for displaying images and playing associated audio content comprising: a plurality of leaves defining pages of said book; a plurality of pairs of transmitters and receivers on said leaves, arranged so that a plurality of said leaves each has a transmitter and a plurality of said leaves each has a receiver, and capacitance coupling between a transmitter and its paired receiver depends upon whether a page of said book is open; a controller configured to provide pulsed signals to said transmitters and receive signals from said receivers; memory for audio content; and an audio playback device; wherein said controller is configured to identify any open page of said book by comparing signals received by said receivers from said transmitters to a threshold value, and, if only one page is open, identify associated audio content relevant to said open page from audio data stored in said memory and play identified audio on said audio playback device.

According to a second aspect of the present invention, there is provided a book for displaying images and playing associated audio content comprising: a plurality of leaves; a plurality of pairs of transmitters and receivers on said leaves of said book; a controller configured to provided signals to said transmitters and receive signals from said receivers to determine which pages of said book are open; memory for audio content; an audio playback device, wherein said book comprises a flexible membrane defining electrical connections to said transmitters, said flexible membrane having a main element extending along the spine of said book and branches extending from said main element, each branch extending to one of said transmitters, such that a plurality of said leaves has at least one of said branches attached.

### BRIEF DESCRIPTION OF THE SEVERAL VIEWS OF THE DRAWINGS

FIG. 1 shows an example of an embodiment of the present invention;

FIG. 2 shows components required for the present invention;

FIG. 3A shows a cross-section through a book such as album 101;

FIG. 3B shows a cross-section through an alternative book 351;

FIG. 4 shows an overview of procedures that take place during operation of the present invention;

FIG. 5 details an expansion of step 402 from FIG. 4;

FIG. 6 gives an example of the calibration procedure at step 402;

FIG. 7 shows an example of levels of signals received;

FIG. 8 shows an example of signals received in use;

FIG. 9 shows an example of transmitters and receivers;

FIG. 10 shows operation of transmitters and receivers in accordance with a first embodiment;

FIG. 11 shows operation of transmitting receivers in accordance with the second embodiment;

FIG. 12 shows a cross-sectional view through a book such as 101;

FIG. 13 shows the electronic components of an alternative book embodying the present invention;

FIG. 14 shows a timing diagram showing signals output by the microcontroller 1350 and the corresponding received signals;

FIG. 15 shows a timing diagram similar to that of FIG. 14 but providing an example where two pages are open;

FIG. 16 shows a flexible membrane 1601 defining the receivers 1321 to 1341 of FIG. 13; and

FIG. 17 shows a membrane 1701 on which are defined the transmitters 1301 to 1320 of FIG. 13.

### DETAILED DESCRIPTION OF THE PREFERRED EMBODIMENTS

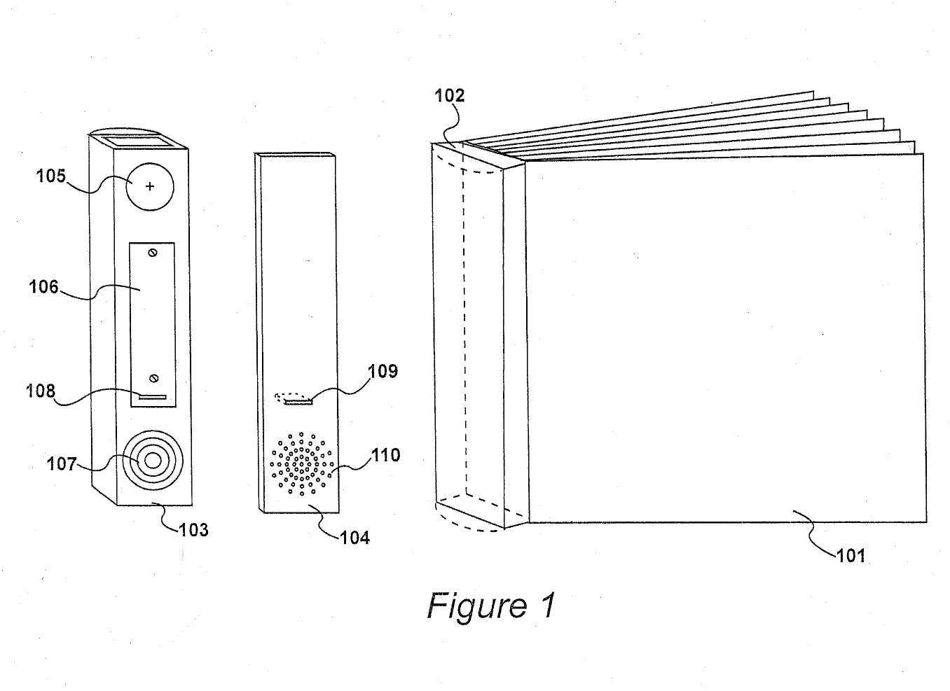

FIG. 1

An example embodiment of the present invention is shown in FIG. 1. In this example the book is a photograph album for displaying photographs but in alternative embodiments any book displaying images (which may include pictures, text, symbols etc) may be used. An album 101 is shown having a spine 102. Spine 102 is made up of components base section 103 and cover section 104. In this example album 101 is a high quality photo album of the type used for wedding photographs etc. When fully assembled, components 103 and 104 are hidden from view inside the spine of album 101. Base section 103 includes a battery 105, a printed circuit board 106 and a speaker 107. In this example printed circuit board 106 includes an input port 108. A number of transmitters and receivers are attached to pages of album 101 as will be later described and signals from these transmitters and receivers pass through opening 109 in cover section 104 into input port 108. In addition, cover section 104 includes a perforated area 110 to allow sound to travel from speaker 107 and be heard by a user. In this example, the components are arranged such that perforated section 110 points inward to the album so that when the album is open sound is directed towards a user. This also means that the perforated section cannot be seen from outside the album. Thus, at first inspection album 101 appears to look like a standard high quality photo album and none of the electrical components can be seen when it is fully assembled. In a further embodiment, a switch is provided for switching the book on or off. Furthermore the switch may provide extra functionality such as also acting as a volume control. This may work by toggling between volume levels for example.

In an embodiment of the invention, a port for input is provided such as a mini-USB port, micro-USB port, or other suitable input port. This allows audio content to be loaded onto memory included as part of the provided electronics. The memory may be Flash™ memory or any other suitable memory. Thus, the book may be preloaded with audio content or may be configurable by an end user to load audio content of their own choosing and, if required, alter or update audio content at a later time. In addition, an input port may be used to load other information such as program code etc and may also be suitable to charge up the battery if plugged into an appropriate power source or computer etc.

Audio content to be loaded onto the book may be received in the suitable format or may require transcoding and/or formatting. The book itself is not capable of highly complex processing therefore the audio content must be appropriately formatted for loading onto the book. In a first embodiment audio content is processed on a separate processor (such as a desktop or laptop computer) before loading it onto the book. For example the audio content may be transcoded into an appropriate format. In an example it may be received as a .wav file or an mp3 etc or may be transcoded into an alternative coding format. Once in the appropriate coding format the content is then processed so that each portion of the content is allocated to a relevant page in the book. These allocations are assigned such that the circuitry on the book itself does not need to perform complex processing in order to identify which portion of content is to be retrieved when a certain page of the book is open.

Depending upon the configuration, the associated audio content allocated to a relevant page may be for example music that is associated with an image on that page, text which is being read aloud as an audio file which also appears on the page, or any other combination of audio and image (where an image may include text, graphics, pictures etc).

Furthermore, there may be provided functionality to connect the book to a computer in order that the associated audio content is played by the computer or a portion of video content associated with a certain page of the book may be played on the computer. This connection may take place via the input port such as a mini USB etc, or alternatively there may be a wireless connection such as Bluetooth™ any similar suitable technology. In addition, a Bluetooth™ connection may be provided from the book to an audio playback device such as wireless headphones or wireless speakers etc. This functionality may be included in addition to or as an alternative to an integral audio playback device and, if provided as an alternative, the wireless audio playback facility may be considered as part of the book as audio cannot be provided without it.

A further additional facility that may be provided is a recording function. Thus it may be possible to record audio content directly onto the book via a microphone contained within the book. This would allow a user to, for example, recorded music onto the memory on the book or record spoken dialog etc.

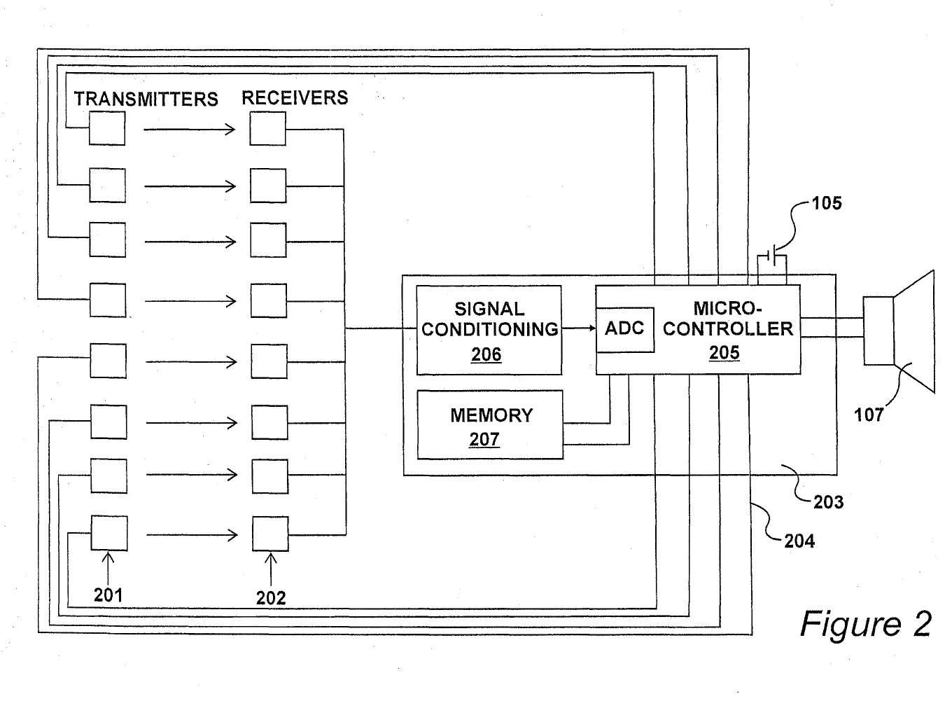

FIG. 2

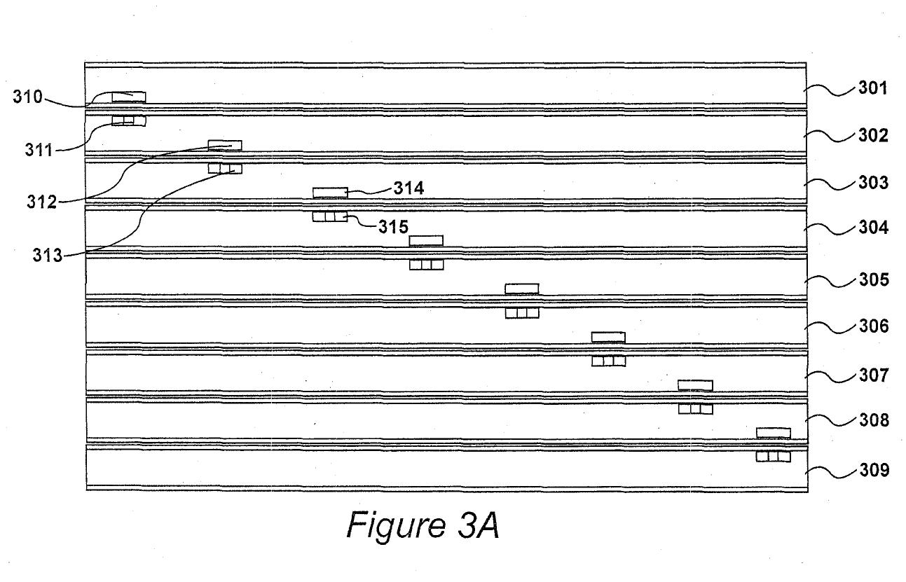

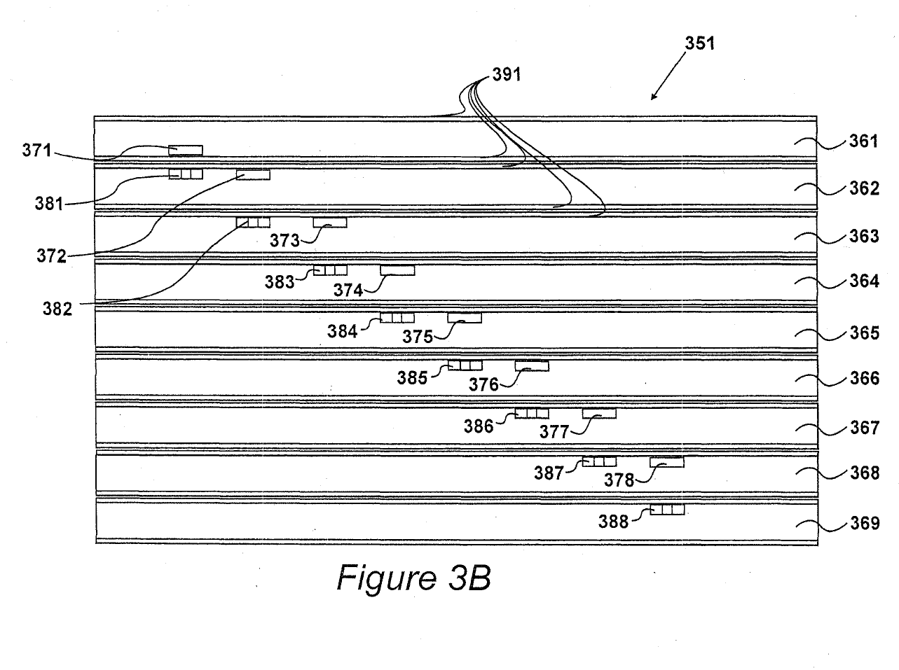

A simplified diagram of components required for the present invention is shown in FIG. 2. A plurality of transmitters are shown at 201 each with their respective receiver as shown at 202, as will be further described with reference to FIG. 3 and later Figures. Signals are generated by transmitters 201 (on receipt of electrical signals from circuitry 203 as shown by connections 204) and received by receivers 202. Signals received by receivers 202 are passed to circuitry 203 which interprets signals received and, by measuring the strength of the various signals, identifies any open page of the book. If only one page is open, a portion of audio content that is relevant to the open page is identified from audio stored locally in memory 207 and played on an audio playback device, in this case speaker 107. In alternative embodiments the audio playback device may have a component within the book and an external component. An example of this is the use of wireless headphones, whereby the wireless transmitter is integral to the book but the headphones themselves are external and not physically connected to the book.

It will be understood that reference herein to a book being open at “one page” refers to the situation where the book is open between consecutive even and odd pages, as one of these pages cannot be open without the other. Thus, when the book is only open at “one page” it is open at only one odd page (and at one even page).

As illustrated in FIG. 2, the circuitry 203 comprises a microcontroller 205 and signal conditioning circuitry 206, itself comprising a suitable amplifier and bandpass filter.

In the present embodiment, each transmitter is connected to a separate output terminal of the microcontroller 205. Thus, the microcontroller is able to supply pulsed signals individually to each transmitter.

The receivers 202 are all electrically connected together and connected to an input of the signal conditioning circuitry 206, which amplifies and filters the signal received from the receivers 202, and provides an output to an analog input of the microcontroller 205.

The microcontroller 205 comprises an analog to digital converter 207, which receives the analogue signal from the signal conditioning circuitry and outputs a digital signal for further processing.

In the present embodiment, the microcontroller is an ASIC (application specific integrated circuit) having a DSP (digital signal processor) core.

It will be understood that the control function performed by the microcontroller may be performed by alternative type of controller. For example, in an alternative embodiment, the microcontroller is replaced by circuitry comprising individual components, including a microprocessor, audio amplifier, RAM (random access memory) etc.

FIGS. 3A and 3B

A cross-section through a book such as album 101 is shown in FIG. 3A. The orientation of this Figure is as if looking from the spine into the book. A plurality of leaves of the book are shown at 301, 302, 303, 304, 305, 306, 307, 308 and 309. Transmitter 310 is shown attached to leaf 301. It is paired with receiver 311 which is attached to leaf 302. In this example the transmitters fall on top of their paired receivers but in alternative configurations different arrangements may be used. Thus further pairs of transmitters and receivers are shown as: 312 and 313 attached to leaves 302 and 303; 314 and 315 attached to leaves 303 and 304; etc. Each pair is offset such that transmitters and receivers only overlay their own paired partner and not any of the other pairs, to avoid interference or noise. The arrangement as shown in this Figure results in pairs being offset vertically when viewed from in front of the book, i.e. along the book parallel to its spine.

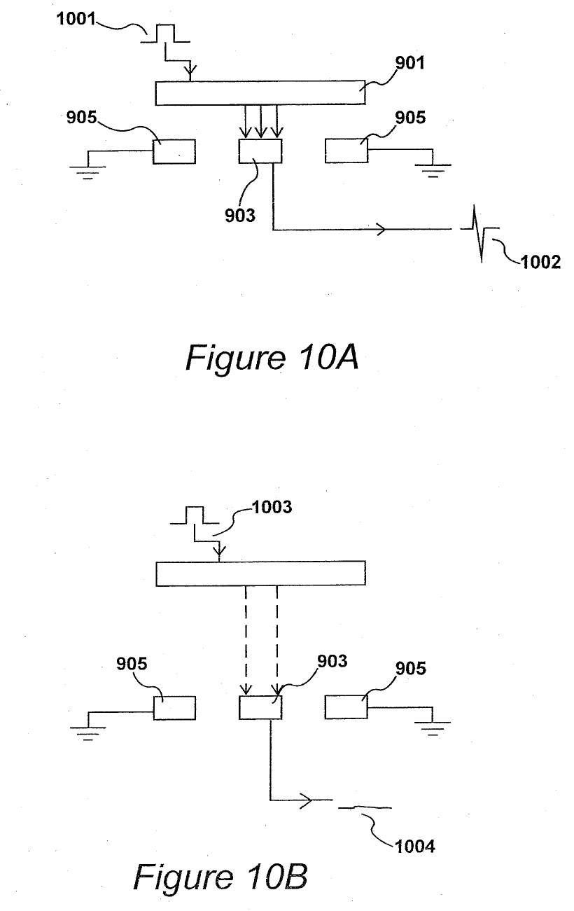

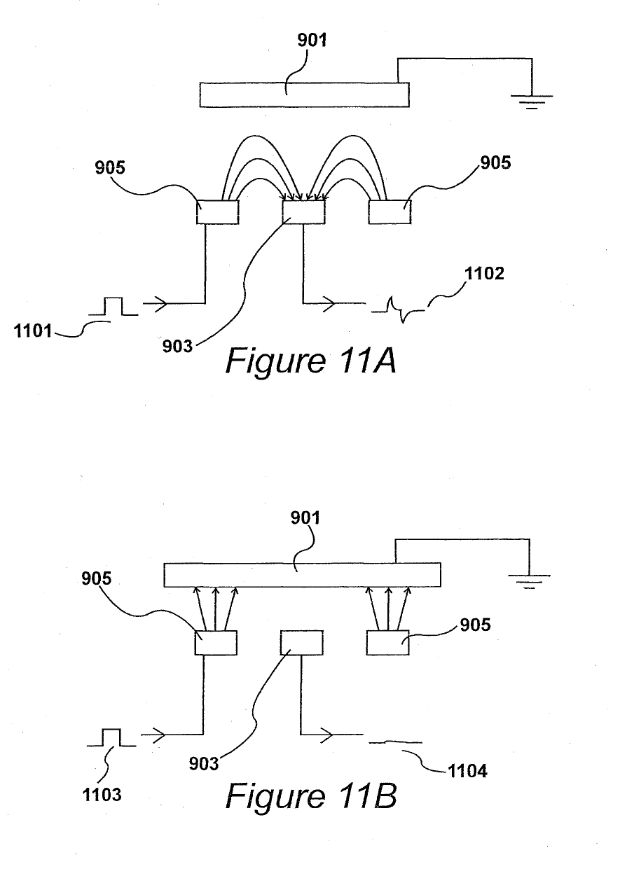

The arrangement of FIG. 3 corresponds with configuration of transmitters and receivers as shown in FIG. 10. Alternatively, transmitters and receivers may be arranged in different formats such as that shown in FIG. 11.

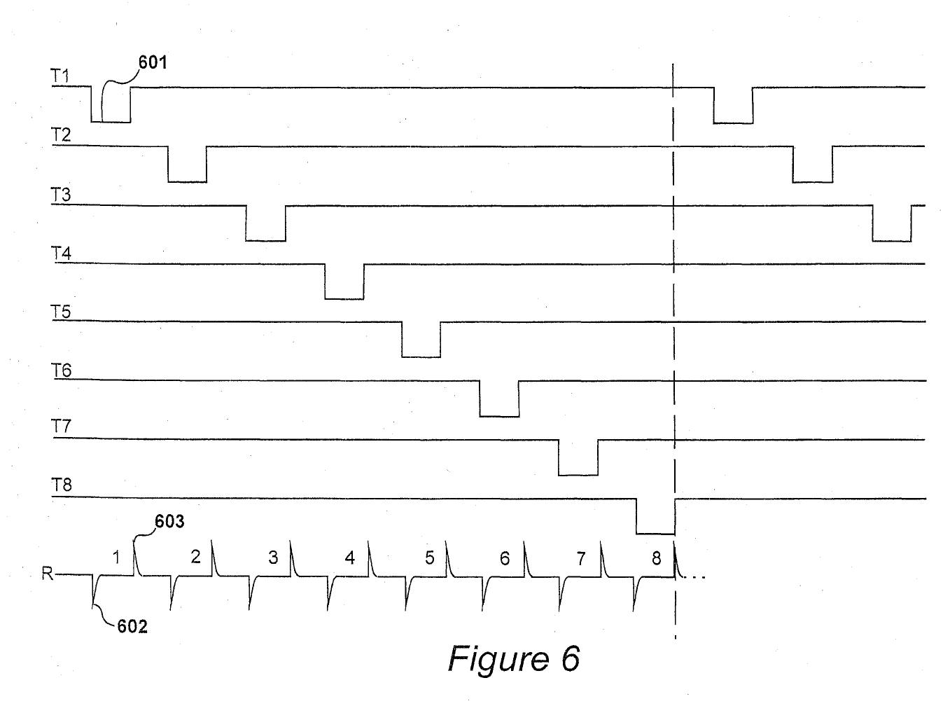

Each of the transmitters and receivers such as 310 and 311 are connected to the microcontroller in printed circuit board 106, as described above with reference to FIG. 2. In use, each of the transmitters transmits a regular pulsed signal and depending upon the strength of the pulse signal received by the respective receivers the microcontroller is able to identify which page or pages of the book are open at any particular moment. This is further described with reference to FIG. 6.

In a further embodiment, rather than processing analog signals as has been described, digital signals may be used. In this case the strength or amplitude of the signal is not the measured factor but instead the width of a digital pulse is measured. This is in turn related to the amplitude of the respective analog signal. Thus an analog signal with high amplitude will be represented by a digital signal with large width, and threshold parameters may be applied in a corresponding way.

An alternative book 351 embodying the present invention is shown in FIG. 3B. The book is substantially the same as book 101. However, the placement of the transmitters and receivers on the leaves of the book 351 differs from that of book 101.

Like book 101 the book 351 has a first leaf 361 supporting just a single transmitter 371, and a last leaf 369 supporting just a single receiver 388. But, all other leaves (362 to 368 inclusive) in between the first and last leaf support a transmitter of one transmitter/receiver pair, and a receiver of another transmitter/receiver pair. For example, the second leaf 362 has receiver 381 (which is paired with transmitter 371) and transmitter 372 (which is paired with receiver 382 on the third leaf). Similarly, the third leaf 363 has a transmitter 373 paired with the receiver 383 (located on the fourth leaf), as well as the aforementioned receiver 382.

Also like book 101, the book 351 has leaves comprising a sheet of card, such as card 352. The card is provided with recesses, formed as indentations, in which the receivers and transmitters are located. The sides of the leaves are provided with an image layer 391 on which the images displayed on the pages of the book are printed. As shown in FIG. 3B, the image layer 391 covers the transmitters and receivers, and so the transmitters and receivers are invisible to the user of the book. The image layer may be formed of a paper material or plastics material that is attached to the card during assembly by an adhesive layer. (For the purposes of clarity of FIG. 3B, the adhesive layers between the image layers and the sheets of card are not shown.)

Unlike book 101 the leaves 362 to 368 of the book 351 each have a transmitter and a receiver located on the same side of the cardboard. This potentially has the disadvantage of increasing the separation between receivers and transmitters forming a transmitter/receiver pair. However, this has been found to be acceptable for the operation of the book for a card thickness up to 3 mm (three millimeters). The advantages of this arrangement are that the card need only be recessed on one side, and the assembly of the book is simplified because a receiver and a transmitter only have to be mounted on one side of a leaf.

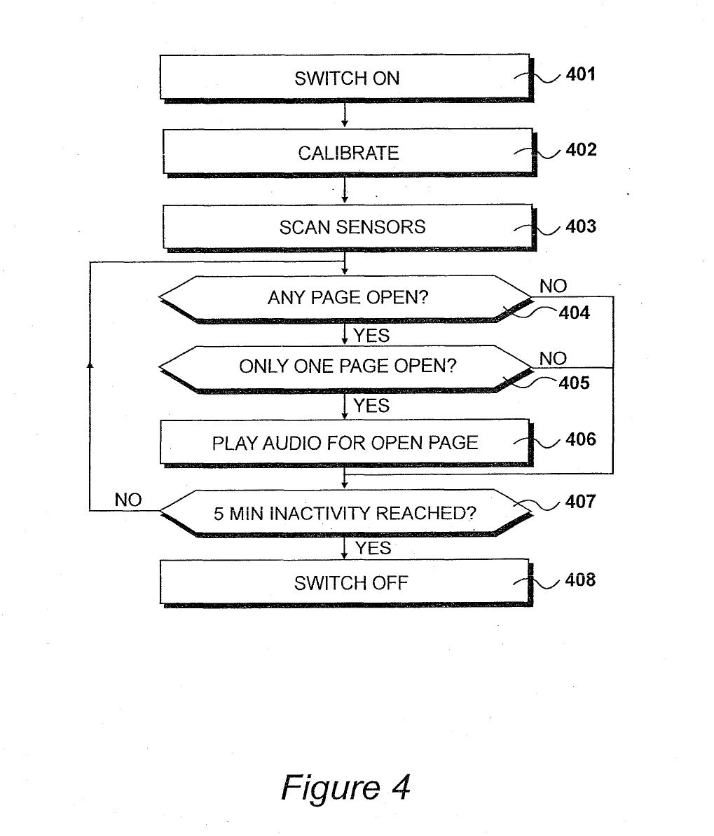

FIG. 4

An example of procedures that take place during operation of the present invention is shown in FIG. 4. At step 401 the book is switched on. In a first embodiment, the transmitters and receivers are configured such that the book automatically switches on upon opening of the first page (or whichever page is open first depending upon the configuration) and in a second embodiment an “on” switch is provided. At step 402 a calibration procedure takes place. The purpose of this is to establish a threshold whereby signals received that are above the threshold identify that the page is closed and signals received below the threshold identify that a page is open (or vice versa in an alternative embodiment). The calibration step occurs each time the book is switched on as changes in humidity, temperature etc may effect the strength of signals transmitted and received.

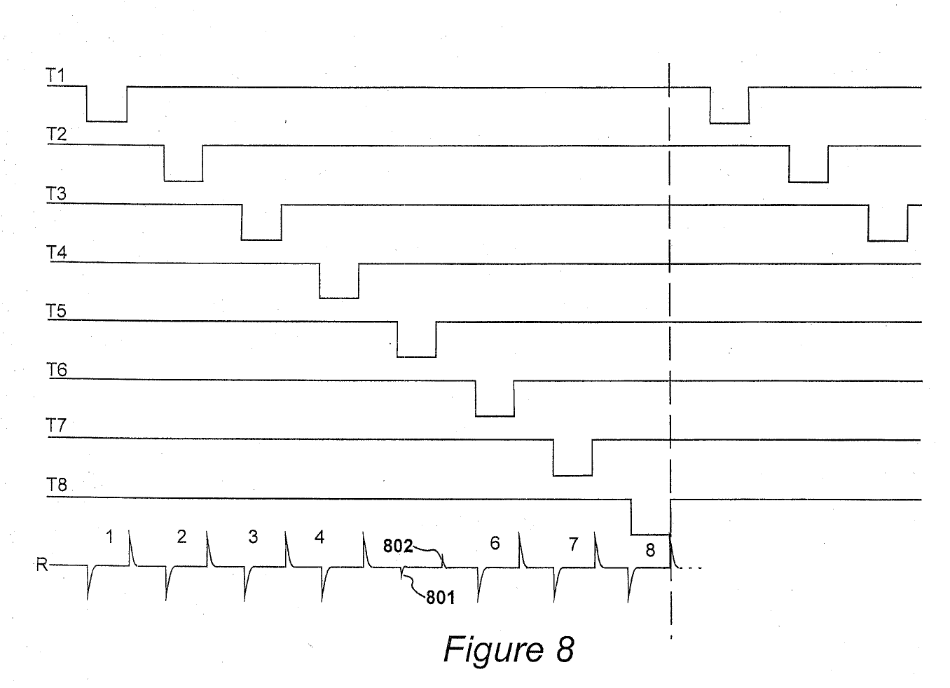

At step 403 the sensors are scanned in turn as is further described with reference to FIG. 8. The scanning process is essentially similar to the calibration process as shown in FIG. 6. After the calibration process has taken place and the threshold has been established, the result of scanning as shown in FIG. 8 can be usefully interpreted in order to determine whether any page or pages are open.

At step 404 a question is asked as to whether any page is open. If this is answered in the affirmative then control passes to step 405 at which a further question is asked as to whether only one page is open. If the question asked at step 404 is answered in the negative indicating that no pages are open then control passes to step 407.

At step 405 if only one page is open (i.e. the book is only open between consecutive even and odd pages) then control passes to step 406 and if more than one page is open as indicated by a negative answer to the question asked at step 405 then control is passed to step 407.

At step 406, which is only reached when one page and only one page is open, the audio content relevant to the open page is identified and played on the audio playback device, in this case a speaker. In alternative embodiments an alternative audio playback device may be provided such as headphones etc.

It should be understood that the situation where more than one page is open may occur every time a page is turned. For example if the book is open at pages 2 and 3, and a leaf is turned to open pages 4 and 5, then during the time that the leaf is being turned, both pages 3 and 5 could be identified as open by the microcontroller. Thus, typically when a leaf is turned, the microcontroller will stop audio playback relating to the first open page before starting playback for the next open page. In this example, a further question is asked at step 407 as to whether five minutes of inactivity have been reached. In further embodiments alternative time periods may be specified, for example ten minutes or fifteen minutes etc. This question is a safeguard to avoid the book being switched on for extended periods and therefore wasting the battery life. If this question is answered in the affirmative then the book switches off at step 408. In alternative configurations, there may be a switch provided to allow for manual switching off, or the on switch may also act as an off switch. If the question asked at step 407 is answered in the negative indicating that the five minutes inactivity have not been reached then control loops back to step 404.

A further functionality may be provided in terms of a low battery and/or critical battery mode. For example, in a low battery mode the book may emit a series of beeps in order to warn a user but may otherwise continue to function as usual. In a critical battery mode the book may beep or provide a similar signal and then switch itself off automatically. Further configurations of warnings and combinations of beeps or other alerts in order to inform the user of the status of the book may be configured.

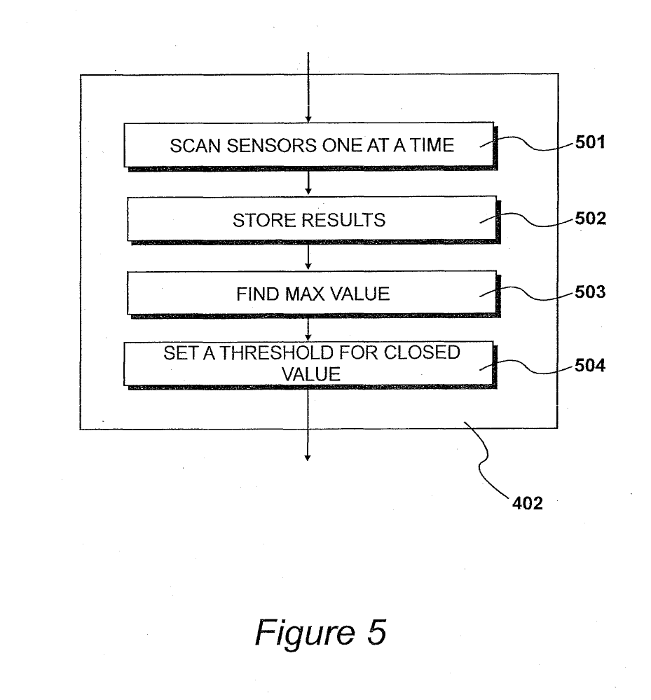

FIG. 5

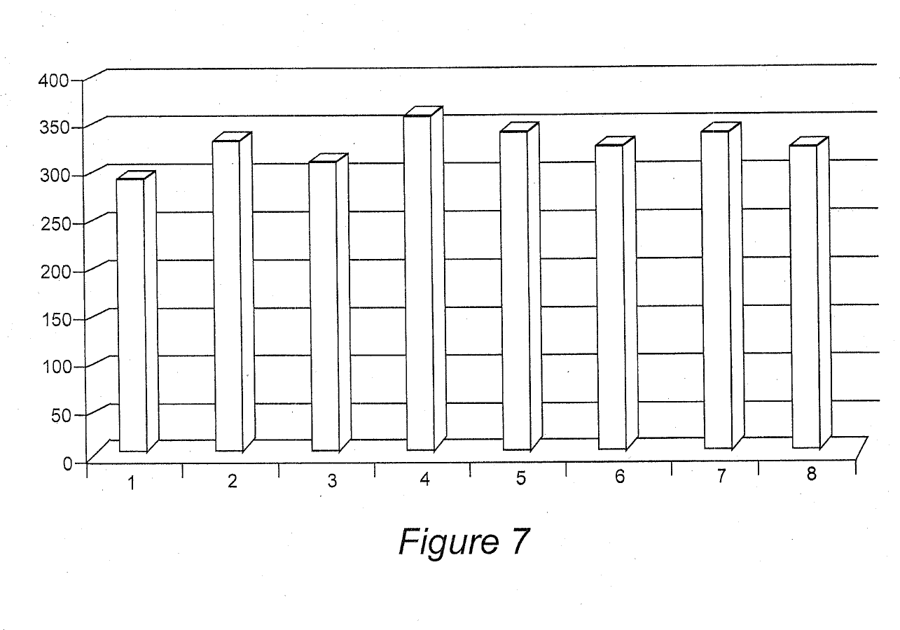

An expansion of step 402 from FIG. 4 is shown in FIG. 5. This is a step of calibrating the sensors. At step 501, the sensors are scanned one at a time as is described with further reference to FIG. 6. At step 502 the results produced from this scan are stored and the maximum value is found at step 503. This is further described with reference to FIG. 7.

As a result of finding a maximum value at step 503 a threshold is calculated at step 504 such that, in this configuration, signals at a level above the designated threshold indicate that a page is closed and signals below the threshold indicate that the page is open. In alternative embodiments this situation may be reversed such that signals below the threshold indicate a closed page and signals above the threshold indicate an open page.

This calibration process occurs each time the book is switched on.

FIG. 6

An example of the calibration procedure at step 402, shown in FIG. 5, is shown in further detail in FIG. 6. The transmitters (labelled here T1 to T8) each, in turn, transmit a pulse. For example, transmitter T1 transmits a pulse as shown at 601. In this configuration, there is a common receiver whose signals that are received are shown at R at the bottom of FIG. 6. Thus, each time any transmitter transmits a pulse this is received by the receiver. For example pulse 601 from transmitter T1 is shown by trough 602 and peak 603 in the R signal. Each subsequent pulse transmitted by each transmitter is picked up and these have been numbered 1 to 8 in the received signal at R.

In this diagram, all eight received pulses appear to be of the same magnitude. However, in reality these will vary a little depending upon external conditions such as temperature/humidity etc. Further representation of this is shown in FIG. 7. For the calibration exercise illustrated in FIG. 6 to take place the book must be fully closed thus the signals received by the receivers are all roughly similar as all receivers are close to their respective transmitters. When one or more pages are open the strength of signal on the open pages will differ from the signal on the closed pages and this will be further described with reference to FIG. 8.

FIG. 7

An example of the levels of signal received by receivers in response to transmissions by each of the transmitters is shown in FIG. 7. It can be seen that there is some degree of variation in the signals received. In this configuration, a high level of signal is received when a page of the book is closed and a low level when a page is open. Thus, a threshold for deciding the page is open or closed can be determined with the aid of the values in this graph. For example, given that all these values are at around 300 to 350 a suggested formula for calculating a threshold is to divide this average (say 320) by 4. This produces a threshold that any page for which the signal received is above 80 will be considered closed and any page to which the signal received is below 80 will be considered open. These thresholds can be adjusted in accordance with environmental conditions or personal preferences. For example, it may be a preference to consider a page open only when it is absolutely open and the book is laying flat where as an alternative circumstances a page being say three quarters open may be sufficient.

FIG. 8

An example of signals received when one page is open is shown in FIG. 8. Signals are transmitted by each transmitter in turn, similar to operation in the calibration procedures as described with reference to FIG. 6. However the stage shown in FIG. 8 is stage 403 where the sensors are being scanned to ascertain whether any pages are open. In this example it can be seen that the trough and peak shown as 801 and 802 in FIG. 8 are significantly smaller than the other troughs and peaks. This indicates that a smaller signal has been received from transmitter 5 to the receiver thereby identifying that the page corresponding to transmitter 5 is open. The threshold as discussed with respect to FIG. 7 can be applied here and as the trough and peak 801 and 802 fall below this threshold the page corresponding to transmitter 5 is identified as open.

In the present embodiment of the invention audio is only played when one and only one page is open. Thus as a result of the received signal shown in FIG. 8 the audio content relevant to page 5 will be identified from audio stored in memory and will be played on the audio playback device, in this case speaker 107.

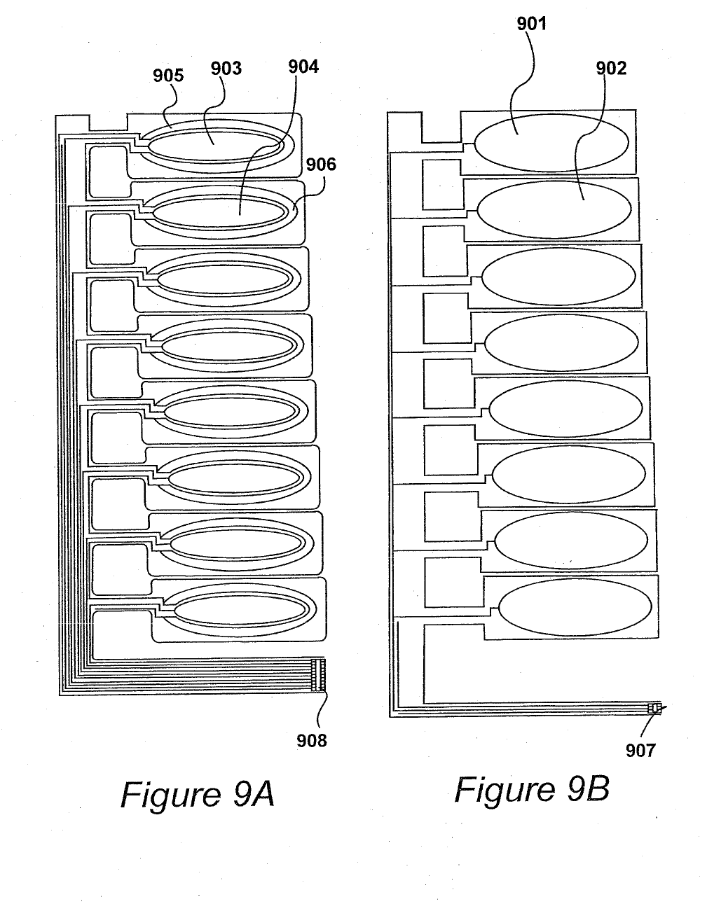

FIG. 9

An example of transmitters and receivers is shown in FIG. 9. The exact configurations may vary, in particular there are two distinct embodiments described in FIG. 10 and FIG. 11 respectively which involve different configurations of receivers and transmitters. In a first example, as is shown in FIG. 10, FIG. 9B shows a plurality of transmitters 901, 902 etc.

Furthermore FIG. 9A shows a plurality of receivers 903, 904 etc each surrounded by an “earthed” plate such as 905 which surrounds receiver 903 and plate 906 which surrounds receiver 904. The transmitters are all linked together and electrically connected to a terminal 907. The receivers are each electrically connected to a respective terminal 908. The terminals 907 and 908 connect to the printed circuit board (shown in FIG. 1 as 106). Thus, the printed circuit board provides signals to the transmitters via terminal 907 and receives signals from the receiver via terminals 908.

Each transmitter and receiver pair are positioned on adjacent pages as was described with reference to FIG. 3. In further embodiments different shapes of transmitters and receivers are used. The operation of this configuration is described with reference to FIG. 10.

In the present embodiment, the electrodes forming the sensors, i.e. the transmitters, receivers and earthed plates, are formed on two flexible membranes 910 and 911. Each membrane is formed from a sheet of a flexible polymer material and the electrodes and electrical tracks providing connections to the electrodes are formed from a layer of copper foil bonded to the polymer sheet. In the present embodiment, the membrane is produced from a polyimide sheet to which a continuous copper foil sheet is bonded. The electrodes and electrical tracks are formed from the continuous copper sheet using photolithography techniques similar to those used conventional employed when making printed circuit boards. The polyimide material in the present embodiment is manufactured by Dupont under the trademark Kapton.

As shown in FIG. 9 the membranes 910 and 910 have a main linear portion 911 and 912 respectively from which branches 913 and 914 extend to one side. At least one electrode is formed on each branch and an electrical track extends from the electrode along the branch and along the main portion. It should be understood that the electrodes each reside on a respective page of the book and the part of the membrane between the electrodes and the main portion are bent as pages are turned. The electrical track on this part of the membrane is therefore repeatedly bent during the use of the book. However, because the track is formed of a continuous copper foil the track may be bent very many times without loss of conductivity.

In the present example each of the membranes has eight branches with a corresponding eight sets of electrodes thus the two membranes form eight sensors. Alternative embodiments are envisaged in which membranes have fewer or more than eight branches.

In a further embodiment, as is described with reference to FIG. 11, components 905, 906 etc are the transmitters which surround receivers 903, 904 etc. In this embodiment 901, 902 etc are earthed plates and the operation of this system is described and shown in FIG. 11.

Plates are earthed in this embodiment by connecting them to the negative of the battery. In alternative configurations this may be achieved by connecting to an additional port of the microcontroller. In this case the port may be held at a high or low potential. The potential used may be chosen to change the field surrounding the sensor and so achieve the desired the capacitive coupling between the transmitter and receiver.

As an alternative to attaching transmitters and receivers to pages of the book, they may be printed using carbon loaded ink. Thus, issues in terms of hiding the thickness of sensors within a page are eliminated. Printed sensors may be hidden in images themselves, in a border for example or in another way within the page. In such embodiments, the electrical connections to the transmitters and receivers are still formed as conductive tracks on a flexible membrane, and the ends of the conductive tracks are bonded to the printed transmitters and receivers using a conductive adhesive.

FIG. 10

FIG. 10A shows a transmitter such as 901 in close proximity to a receiver such as 903. In an alternative embodiment, 903 may be the transmitter and 901 the receiver. In a further alternative embodiment, plates 903 may also be surrounded by grounded plates. Earthed plate 905 is shown in two components due to the cross-sectional nature of this drawing. Signals are transmitted from transmitter 901 and received by receiver 903. A pulsed signal is shown at 1001 as input to transmitter 901 and the response is shown at 1002 as being received by receiver 903. Similar components are shown in FIG. 10B, however here transmitter 901 is relatively distant from receiver 903 and earthed plates 905. Thus, the configuration in FIG. 10A represents when a page is closed and the configuration of FIG. 10B represents when a page is open therefore the components are further apart from each other. In FIG. 10B, again a pulse signal is input as shown at 1003 to a transmitter 901. Furthermore a signal is received by receiver 903 as is shown at 1004, however in this case the reaction to the pulse is very weak because less signal is received due to the distant nature of the transmitter and receiver from each other.

Thus, in the configuration illustrated in FIG. 10A and 10B a strong response is received when a page is closed and the transmitter and receiver are close together and a weaker response is received when a page is open and the transmitter and receiver are relatively far apart.

It may be noted that in this embodiment, the earthed plate surrounding a receiver acts as a shield electrode, shielding the receiver from electromagnetic signals that have not been transmitted by the corresponding transmitter.

FIG. 11

An alternative configuration is shown in FIGS. 11A and 11B. In this embodiment, a stronger signal is received when the components are further apart when a page is open and the weaker signal is received when the pages are closed together.

In this embodiment 901 is an earthed plate and the transmitter is shown at 905 to be transmitting to receiver 903. Due to capacitance coupling the signal as illustrated at 1101 input to transmitter 905 is received strongly at 903 and is represented at 1102. The earthed plate 901 is relatively far from the transmitter and receiver and does not inhibit the transmission of signals.

In FIG. 11 B the earthed plate 901 is shown relatively close to transmitter 905 and receiver 903. In this case the proximity of the earthed plate 901 reduces the capacitance coupling such that little or no signal reaches the receiver 903. This is shown by the signal being input at 1103 and the very weak response being shown at 1104.

Thus the configuration shown in FIG. 11 represents a scenario whereby when a page is open a strong signal is received due to capacitance coupling and the relative distance of the earthed plate of the other components and when a page is closed there is a relatively weak signal transmission as the capacitance coupling is reduced by the earthed plate. This is therefore an opposite effect to that described and shown in FIG. 10. However depending upon the configuration of the system either approach works. The threshold is calculated accordingly such that a received signal to one side to the threshold represents open and the other side represents closed, the assignment of which side of the threshold to which state can be altered accordingly.

Thus, in this embodiment, the earthed plates act as switching electrodes, in that it is the movement of an earthed plate relative to the transmitter and receiver that results in the change in the magnitude of the received signal. However, when the corresponding page is closed such that the earthed plate is close to the transmitter and receiver, the earth plate also acts to shield the receiver from receiving electromagnetic noise, or unwanted signals.

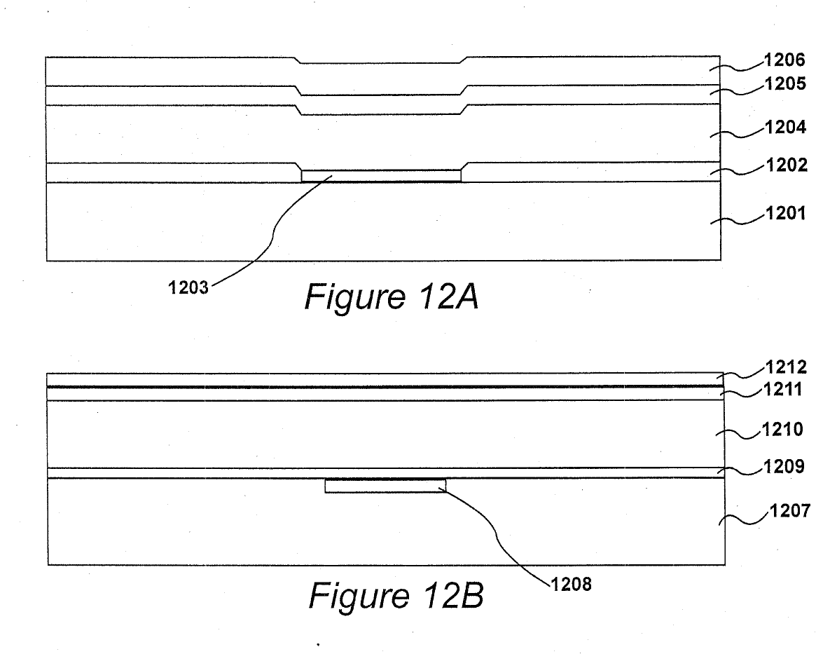

FIG. 12

Book 101 may be displaying high quality images such as wedding photographs etc. It is therefore important that the presence of components such as transmitters and receivers behind the images does not in any way impact upon the quality of presentation of the images. FIG. 12A shows a number of layers which make up a page of the book. A first layer 1201 is cardboard topped with a film adhesive 1202 with the sensor (transmitter, receiver or earthed plate) present at 1203. Film is present at 1204 topped with film adhesive at 1205 on the picture itself at 1206. As can be seen in FIG. 12A in this configuration when the layers of the book are adhered together, which may be a process involving pressure and/or heat, there is a tendency for a depression in each layer to occur which will affect the quality of the displayed image at 1206. This is highly undesirable but a solution is shown in FIG. 12B.

In FIG. 12B a cardboard layout is shown at 1207 with the sensor membrane (transmitter, receiver or earthed plate) recessed into the cardboard as shown at 1208. A layer of adhesive is added at 1209 followed by film at 1210, a further layer of adhesive at 1211 ad the image itself at 1212. By recessing the sensor into the cardboard the depression which occurred in FIG. 12A is eliminated in 12B and the image displayed from the book is in perfect condition.

To recess the sensor membrane in this way the cardboard sheet forming part of a page of the book is provided with a recess having the shape and position of the part of the membrane it is to receive. Thus, as each transmitter and receiver pair is offset with respect to every other such pair, each cardboard sheet is provided with a uniquely formed recess.

In the present embodiment, the cardboard has a thickness of 1 mm and is provided with a recess having a depth of 0.1 mm. The recess is formed by pressing the cardboard by a suitably formed tool by a predetermined pressure. (The pressure is determined empirically by performing trial presses using the same tool on a sheet of the same cardboard material and using a range of pressures.)

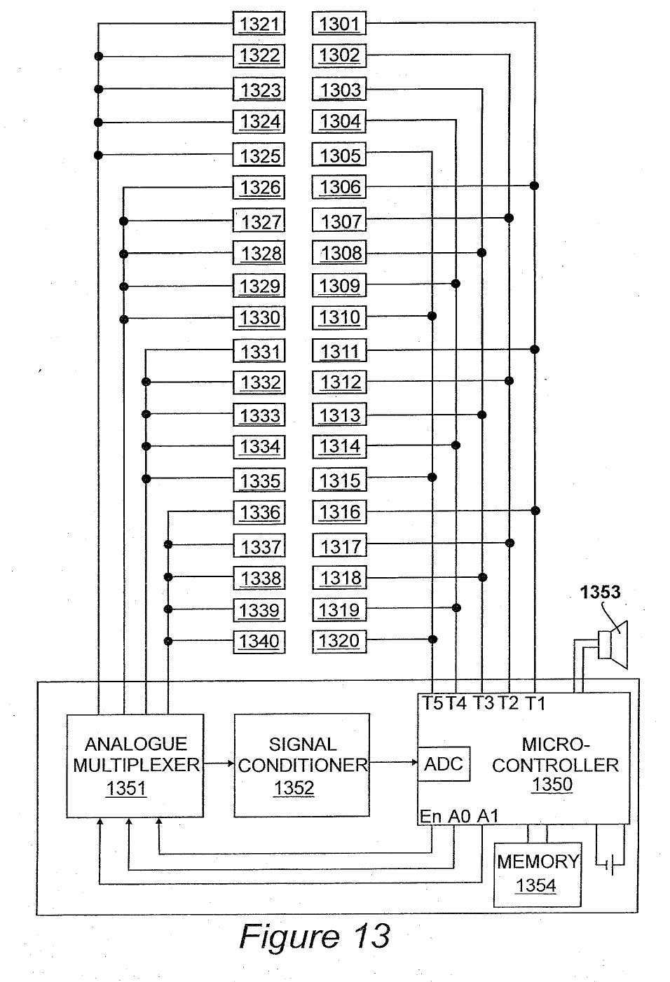

FIG. 13

In each one of the above described embodiments, a book has each individual transmitter electrically connected to a separate output port of a microcontroller and the receivers are connected together to provide a single input supplied to the microcontroller (after conditioning). This arrangement is limited by the number of ports provided on the microcontroller, and typically, microcontrollers having more ports tend to be more expensive. The following described embodiment provides an arrangement that allows for many more pages to be sensed, while keeping the number of output ports on the microcontroller at a commercially practical amount.

The electronic components of an alternative book embodying the present invention is shown in FIG. 13. The book operates in a similar manner to those described above and comprises conductive pads located on the leaves of the book to form receivers and corresponding transmitters. In the present embodiment the sensors are each formed of a transmitter located on one leaf of the book and the corresponding transmitter located on the next leaf. For example, a transmitter 1301 is located on the first leaf of the book and a receiver 1321 is located on the second leaf of the book. The book has twenty transmitters (labelled 1301 to 1320 respectively) which are located on twenty consecutive pages, and a corresponding twenty receivers (labelled 1321 to 1340 respectively) located on a corresponding twenty pages. Thus, for example, transmitter 1302 is located on the second leaf of the book while the corresponding receiver 1322 is located on the third leaf of the book, and transmitter 1303 is located on the third leaf of the book while corresponding receiver 1323 is located on the fourth leaf of the book, etc.

As shown in FIG. 13 the transmitters are electrically connected in groups of four, such that every fifth transmitter is connected together and connected to one of the outputs of the microcontroller. For example, transmitters 1301, 1306, 1311 and 1316, on the first, sixth, eleventh and sixteenth leaves of the book are electrically connected to together and connected to output port T1 of the microcontroller 1350. Similarly transmitters 1302, 1307, 1312 and 1317 are connected to output port T2, etc.

The receivers 1321 to 1340 are electrically connected together in groups of five, such that receivers on five consecutive leaves of the book are electrically connected together. For example receivers 1321, 1322, 1323, 1324 and 1325 are all connected together, and similarly receivers 1326, 1327, 1328, 1329 and 1330 are all electrically connected together, etc. Each group of five receivers is electrically connected to an input port of an analog multiplexer 1351. Thus receivers 1321 to 1325 are connected to input port R1, receivers 1326 to 1330 are connected to input port R2, receivers 1331 to 1335 are connected to input port R3 and receivers 1336 to 1340 are connected to input port R4.

The analog multiplexer 1351 has an enable port and address ports A0 and A1 connected to respective ports of the microcontroller 1350, such that the microcontroller 1350 is able to select which of the four signals provided to inputs R1, R2, R3, R4 of the analog multiplexer are connected to an output of the analog multiplexer.

The output from the analog multiplexer is supplied to signal conditioning circuitry 1351 comprising an amplifier, bandpass filter and rectifier. The signal conditioning circuitry 1351 receives an analog signal from the multiplexer having negative and positive pulses which it amplifies, filters and rectifies to produce an output signal that it supplies to an input port of the microcontroller 1350.

In the present embodiment, the signal produced by the signal conditioning circuitry is in the form of a series of analog pulses and consequently, the pulses are applied to the analog input of the microcontroller 1350. As described previously, the analog pulses are converted to digital signals by means of an analog to digital converter resident in the microcontroller.

It will be understood from FIG. 13 that this arrangement provides a matrix in which each of the transmitter lines T1, T2, T3, T4 and T5 has only one transmitter corresponding to a receiver within each of the four groups corresponding to the input ports R1, R2, R3 and R4. For example, the transmitter and receiver pair 1301, 1321 is the only pair for which the output line is T1 and the receiver line is R1. Thus, by successively transmitting signals on the output ports T1, T2, T3, T4 and T5 and measuring inputs received on R1, R2, R3 and R4 it is possible to determine which of the transmitter/receiver pairs are in close proximity, corresponding to a closed page, and which transmitter/receiver pairs are separated, corresponding to an open page.

In a similar manner to the previously described embodiments, the book comprises memory 1354 for storing audio data corresponding to pages of the book. In addition, the microcontroller 1350 is connected to a loud speaker 1353 for producing audio signals. Thus, when the microcontroller 1350 detects that one page (and only one page) of the book is open, it retrieves audio data corresponding to that one page and provides signals to the loud speaker 1353, so that audio signals relating to the open page are played.

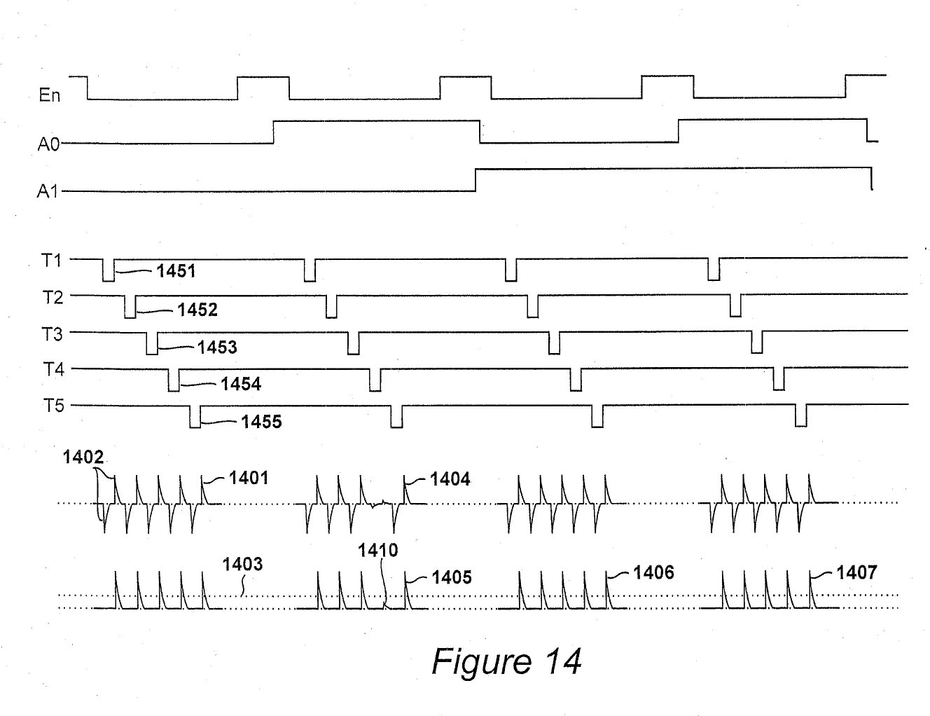

FIG. 14

A timing diagram showing signals output by the microcontroller 1350 and corresponding received signals are shown in FIG. 14.

As illustrated in FIG. 14, the microcontroller 1350 provides an enable signal (labelled En in FIG. 14) that disables the analog multiplexer for short periods in which voltages applied to the control lines A0 and A1 are altered. (Signals applied to control lines A0 and A1 are similarly labelled A0 and A1 in FIG. 14.) Initially, control lines A0 and A1 are set to zero resulting in the analog multiplexer 1351 providing a signal 1401 to the signal conditioning circuitry 1352 as received at its input port R1. The microcontroller 1350 then sequentially provides a square pulse (1451, 1452, 1453, 1454, 1455) to each of its outputs T1, T2, T3, T4 and T5. (Signals applied to output ports T1, T2, T3, T4 and T5 are correspondingly labelled in FIG. 14.) Thus, initially a square pulse is provided to output port T1 so that a pulse is applied to transmitter 1301, resulting in a pulse being received by receiver 1321 and provided to input port R1 of analog multiplexer 1351. As illustrated in FIG. 14 this pulse 1402 comprises a negative-going portion followed by a positive-going portion.

Similarly, the square pulse applied to output ports T2 of microcontroller 1350 results in a pulse being transmitted from transmitter 1302 and a pulse being received at receiver 1322 and supplied to input port R1 of analog multiplexer 1351. This process continues with the square pulses provided at output ports T3, T4 and T5 resulting in a set of five pulses having negative and positive going components being received at the analog multiplexer input port R1 and supplied to signal conditioning circuitry 1352.

The signal conditioning circuitry 1352 amplifies filters and rectifies the signal received from the analog multiplexer 1351 and provides the positive going pulses to the analog input of the microcontroller 1350. In the present example, these first five pulses all have an amplitude greater than the threshold value 1403, and consequently the microcontroller determines that the corresponding pages are all closed.

The microcontroller then disables the analog multiplexer and sets the control line A0 to 1, so that a signal 1404 received at input port R2 of analog multiplexer 1351 is supplied to signal conditioning circuitry 1352. The microcontroller 1350 then enables the analog multiplexer and again provides sequential square pulses to output ports T1 to T5. This time, in the present example, the fourth pulse 1410 of the five pulses is considerably reduced in amplitude, as shown in FIG. 14, such that it is less than the threshold value 1403. As a result, the microcontroller 1350 determines that the page corresponding to transmitter line T4 and input port R2 is open. i.e., the page corresponding to transmitter 1309 and receiver 1329 is open. It may be noted that the remaining pulses of the signal 1405 received via multiplexer input R2 and provided to the analog input of the microcontroller 1350 are all above the threshold value 1403 and consequently the microcontroller 1350 determines that the corresponding pages are closed.

This process continues with the microcontroller setting the control lines A0 and A1 to 0 and 1 respectively and supplying sequential pulses to output ports T1 to T5 and receiving a signal 1406 from receivers 1331 and 1335 via input port R3 of analog multiplexer 1351. The microcontroller 1350 then sets both the control lines A0 and A1 to 1 and again generates the square pulses to output ports T1 to T5 and monitors corresponding pulses 1407 received via receivers 1336 to 1340 and input port R4 of analog multiplexer 1351.

As shown in FIG. 14, in the present example, only pulse 1410 corresponding to transmitter 1309 and receiver 1329 is found to be below the threshold value 1403 and so only one page (that corresponds to that pulse) is determined to be open. Consequently, microcontroller 1350 provides a suitable output signal to loudspeaker 1353, thereby generating audio output corresponding to the page that is open.

The microcontroller 1350 then resets both of the control lines A0 and A1 to 0 and the process illustrated by FIG. 14 is repeatedly repeated. Thus, the microcontroller 1350 continuously determines which pages are closed and which are open.

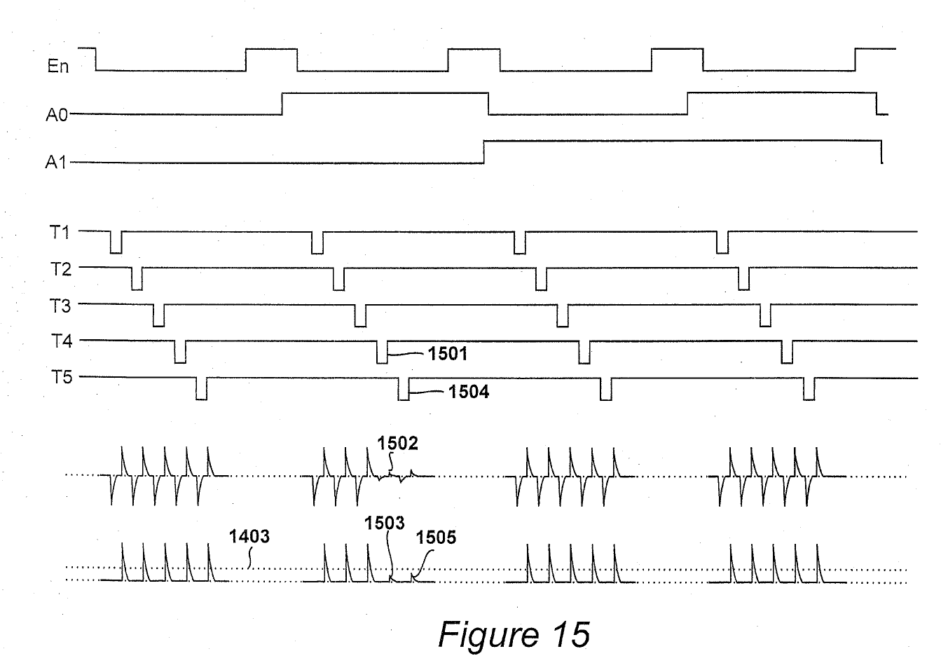

FIG. 15

A timing diagram showing similar signals to those of FIG. 14 are shown in FIG. 15 but in this example a page is being turned and so two pages of the book are open.

In this example, a leaf of the book having a page corresponding to pulse 1410 of FIG. 14 is being turned and consequently that page and the subsequent page are both partially open. Consequently, capacitance coupling between two sets of transmitters and receivers is reduced, resulting in two successive pulses of reduced amplitude being supplied to microcontroller 1350. Specifically, a square pulse 1501 provided at output port T4 to transmitter 1309 causes only a weak pulse 1502 to be received at receiver 1329 and supplied to input port R2 of analog multiplexer 1351. Thus, only a weak pulse 1503 is supplied via signal conditioning 1352 to the analog input port of microcontroller 1350. Similarly, the square pulse 1504 supplied to output port T5 and transmitter 1310 is only weakly received at receiver 1330 and subsequently supplied to the microcontroller 1350 via input port R2 of analog multiplexer 1351 and signal conditioning circuitry 1352. Thus, the microcontroller 1350 receives two pulses 1503 and 1505 having amplitudes that are less than the threshold value 1403 and consequently the microcontroller determines that two pages of the book are open. Because more than one page is determined to be open, the microcontroller does not provide any signal to loudspeaker 1353 and the audio output is, at least temporarily, terminated.

The microcontroller 1350 continues to transmit signals to transmitters in this manner and monitor received signals until it again determines that only one page is open. It then resumes audio output corresponding to the currently open page.

The above-described embodiment has twenty transmitter/receiver pairs but it should be understood that this matrix type system may be applied to many different arrangements having various numbers transmitter/receiver pairs. For example, by increasing the number of output ports from five to six a system may be produced comprising twenty-four transmitter/receiver pairs. Alternatively, an analog multiplexer may be used having more than just four input ports. For example, an analog multiplexer having eight inputs may be used in a system having forty transmitter/receiver pairs. In this embodiment an additional control line (A2) is required in order to provide sufficient addresses for the number of inputs. (In general, for N address lines the analog multiplexer may have up to 2^{N} input ports.)

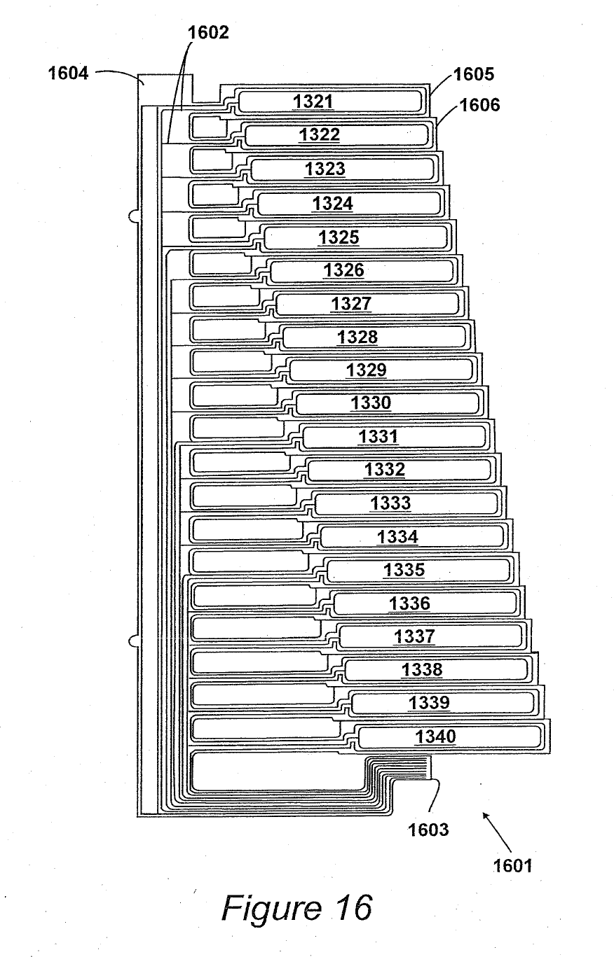

FIG. 16

A flexible membrane 1601 defining the receivers 1321 to 1341 is shown in FIG. 16. The receivers are in the form of conductive pads, and a conductive track 1602 provides a conductive path from each of the receivers to a terminal end 1603 of the membrane, to provide electrical connection to electronic circuitry comprising the analog multiplexer 1351.

The membrane 1601 has a main linear portion 1604, which, in use, extends along the spine of the book, and twenty branches, such as branches 1605 and 1606, extending from the main linear portion 1604. Thus, each of the receivers is located on one of the twenty branches.

Each of the conductive pads forming a receiver is surrounded by a conductive track, such as conductive track 1607, which is “earthed” during use. Thus, the conductive tracks, such as track 1607 provide a degree of electromagnetic shielding for the receivers 1321 to 1340.

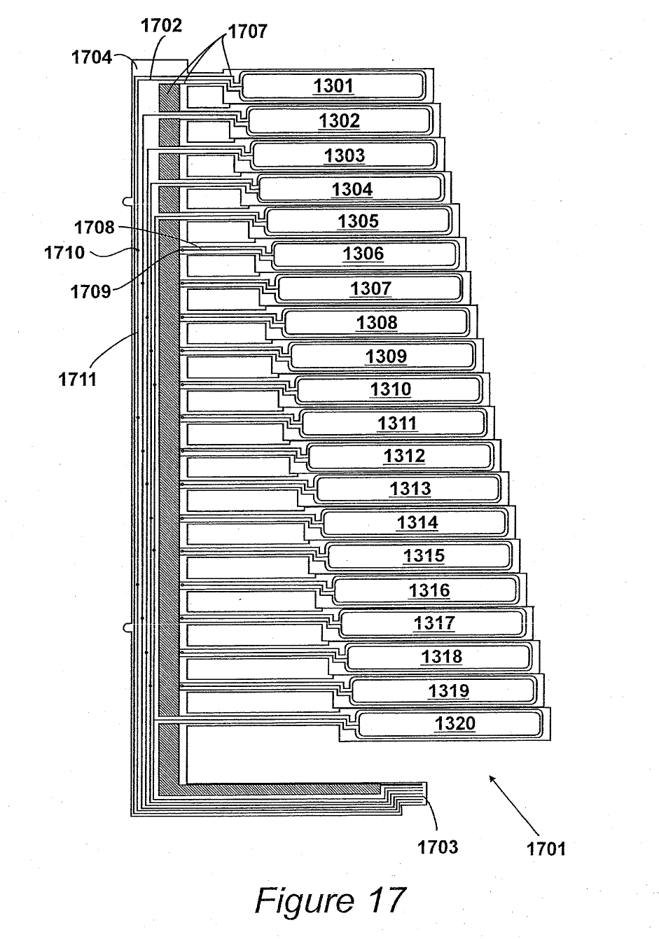

FIG. 17

A membrane 1701 on which are defined the transmitters 1301 to 1320 is shown in FIG. 17. Membrane 1701 is similar to membrane 1601 in that each of the conductive pads (1301 to 1320) are electrically connected to a terminal end 1703 of the membrane 1701 by conductive tracks, such as conductive track 1702. A1so, the conductive pads defining the transmitters 1301 to 1320 are surrounded by a conductive track, such as conductive track 1707, which in use is “earthed” to provide further electromagnetic shielding.

The membrane 1701 differs from membrane 1601 in the configuration of the conductive tracks, such as track 1702, to the transmitters. The reason for this difference in the layout will be understood from observing the arrangement in FIG. 13, where it may be seen that some of the conductive tracks to the transmitters must cross while remaining insulated from one another (whereas those to the receivers do not). This is achieved, in the present embodiment, by having a membrane with conductive tracks on each of its two surfaces, and plated through holes providing connections between tracks on the two surfaces. For example, a conductive track 1708 extends from transmitter 1306 to a plated-through hole 1709, a conductive track (not shown) on the reverse side of the membrane extends between the plated-through hole 1709 and a second plated-through hole 1710, and a conductive track 1711 extends from the second plated-through hole 1710 to the terminal end 1703 of the membrane. As illustrated in FIG. 17, each of the transmitters 1306 to 1319 are electrically connected to the terminal end 1703 of the membrane 1701 in this manner. Thus, all of the transmitters 1301 to 1320 are electrically connected to the terminal end 1703 via 5 conductive tracks, such as conductive track 1711, which extend along the main linear portion 1704 of the flexible membrane 1701.

The conductive pads and tracks are created on the flexible membranes 1601 and 1701 in the manner described previously for membranes 910 and 911. However, it will be understood that the membrane 1701 is formed of material having copper foil on both sides of the sheet of flexible polymer material.

In an alternative embodiment, the membrane 1701 is produced with conductive tracks on just one of its surfaces. In this embodiment, instead of plated-through holes and conductive tracks on the reverse side of the membrane, insulated wires are soldered to the membrane provide additional conductive links. For example, plated-through holes 1709 and 1710 are replaced by conductive pads onto which are soldered respective ends of a wire.

In the above-described embodiments, the book recalibrates itself when it is switched on. Thus, compensation is made for variations in battery voltage, and environmental conditions, such as humidity and temperature that may effect the amplitude of the signals received at receivers. However, in an alternative embodiment the microcontroller does not perform a separate calibration process to determine a threshold value. Instead, it determines whether a page of the book is open by comparing individual signals received from receivers during normal operation.

In this alternative embodiment, the microcontroller continuously measures amplitudes and widths of pulses received by receivers. When pulses for all sensors (i.e. transmitter/receiver pairs) have been measured the microcontroller determines which pages should be identified as open by comparing amplitudes of the pulses. Specifically, it finds the ratio of the amplitudes of the smallest pulse and the second smallest pulse, and if the ratio is less than a predetermined value (typically set at 0.8) then it identifies the smallest pulse as relating to an open page of the book. Also if the ratio of amplitudes of the second smallest pulse and third smallest pulse is also less than 0.8 it will identify the second smallest pulse as also relating to an open page. (As described previously, if more than one page is identified as open then no audio is played by the microcontroller.)

In one embodiment, the microcontroller has a second test for determining whether a page is open or closed. In cases where a page has previously been identified as open, but the amplitude of the respective pulse is no longer less than 0.8 times that of the next largest pulse, then the microcontroller compares pulse widths. In one embodiment, the ratio of the width of the shortest pulse to the second shortest pulse is determined, and if the ratio is greater than a predetermined value then the microcontroller does not play audio signal.

An example of this is where one page of the book is open and a leaf is being turned to view the next page. The pulse signal received by the receiver relating to the next page drops and consequently two pages are determined as open. As a result the microcontroller stops playing audio signal. Because the original open page is being closed, the amplitude of the pulse received by the respective receiver rises, such that the amplitude comparison made by the microcontroller determines that that page is closed. However, the microcontroller only identifies that page as closed when the comparison of pulse widths also shows that only one page is open.

1. A book for displaying images and playing associated audio content comprising:
a plurality of leaves defining pages of said book;
a plurality of pairs of transmitters and receivers on said leaves, arranged so that a plurality of said leaves each has a transmitter and a plurality of said leaves each has a receiver, and capacitance coupling between a transmitter and its paired receiver depends upon whether a page of said book is open;
a controller configured to provide pulsed signals to said transmitters and receive signals from said receivers;
memory for audio content; and
an audio playback device;
wherein said controller is configured to identify any open page of said book by comparing a parameter of signals received by said receivers from said transmitters, and, if only one page is open, identify associated audio content relevant to said open page from audio stored in said memory and play identified audio on said audio playback device.

2. The book of claim 1 wherein each transmitter and its paired receiver are located on the same leaf, and said book comprises an additional electrode located on each one of a plurality of said leaves, such that when the book is closed one of said transmitters and one of said receivers are located on one leaf and one of said additional electrodes is located on an adjacent leaf adjacent to said transmitter and receiver.

3. The book of claim 2, wherein said additional electrodes are electrically connected to one side of a direct current power source, or to a port of said controller.

4. The book of claim 1, wherein said receivers are connected together and said controller is configured to supply a signal pulse to each said transmitter in turn.

5. The book of claim 1, wherein each of said pairs of transmitters and receivers, the transmitter is located on one leaf and the receiver is located on an adjacent leaf and positioned such that when the book is closed the receiver is adjacent to the transmitter.

6. The book of claim 5, wherein said book comprises a plurality of shield electrodes configured to be held at a fixed electrical potential and each receiver is partially surrounded by one of said shield electrodes.

7. The book of claim 6, wherein said shield electrodes are electrically connected to one side of a direct current power source.

8. The book of claim 1, wherein electrical connections to said transmitters are defined as tracks on a flexible membrane.

9. The book of claim 8, wherein said transmitters are formed on said flexible membrane.

10. A book according to claim 1, further comprising an input port for loading audio content into said memory.

11. A book according to claim 1, wherein said audio playback device is a speaker mounted facing inwards to the book.

12. A book according to claim 1, wherein said transmitters and receivers are fitted into recesses in a page to ensure a flat surface on said displayed images.

13. A book according to claim 1 wherein said controller and memory are mounted inside the spine or cover of said book.

14. A book according to claim 1 wherein each receiver-transmitter pair is positionally offset from the other pairs.

15. A book according to claim 1, further comprising:
a microphone to record audio content.

16. A book according to claim 1, further comprising a multiplexer having a plurality of input terminals, and each input terminal is connected to a separate set of said receivers.

17. A book according to claim 1 wherein said parameter is the amplitude of a pulse.

18. A book according to claim 17 wherein said controller is configured to compare amplitudes of pulses to determine if a page is open.

19. A book according to claim 18 wherein said controller is additionally configured to compare widths of pulses to determine if a page is open.

20. A book according to claim 1 wherein said controller is configured to compare widths of pulses to determine if a page is open.

21. A book according to claim 1 comprising a port for providing communication between said controller and a computer.

22. A book for displaying images and playing associated audio content comprising:
a plurality of leaves;
a plurality of pairs of transmitters and receivers on said leaves of said book;
a controller configured to provided signals to said transmitters and receive signals from said receivers to determine which pages of said book are open;
memory for audio content;
an audio playback device,
wherein said book comprises a flexible membrane defining electrical connections to said transmitters, said flexible membrane having a main element extending along the spine of said book and branches extending from said main element, each branch extending to one of said transmitters, such that a plurality of said leaves has one of said branches attached.

23. The book of claim 22, wherein said flexible membrane defines said transmitters.

24. The book of claim 23, wherein said leaves are provided with recesses and said transmitters are located within said recesses.

25. The book of claim 22, wherein said receivers and electrical connections to said receivers are defined on a flexible membrane.
